(19) United States
(12) Patent Application Publication
(10) Pub. No.: US 2004/0074714 A1
(43) Pub. Date: Apr. 22, 2004

(54) Hydraulic brake apparatus for a vehicle

(75) Inventors: Shigemitsu Nohira, Kariya City (JP); Satoshi Kaminaka, Kariya City (JP); Kyosuke Hata, Kariya City (JP)

Correspondence Address: BURNS DOANE SWECKER & MATHIS L L P, POST OFFICE BOX 1404, ALEXANDRIA, VA, 22313-1404, US

(73) Assignee: ADVICS CO., LTD.

(21) Appl. No.: 10/660,724

(22) Filed: Sep. 12, 2003

(30) Foreign Application Priority Data
Sep. 13, 2002 (JP) 2002-268800

(51) Int. Cl. B60T 11/10

(52) U.S. Cl. 188/152

(57) ABSTRACT

The present invention is directed to a hydraulic brake apparatus capable of reducing a hysteresis caused by increase and decrease of braking input force, wherein a regulator chamber is defined ahead of a control piston, and a counter-force pressure chamber is defined to communicate with the regulator chamber. An auxiliary pressure source is provided for supplying hydraulic brake pressure to the counter-force pressure chamber, to move a pressure increase valve and a pressure decrease valve in a direction opposite to a direction thereof moved by the control piston. A first check valve is provided for normally preventing the flow of brake fluid from the counter-force pressure chamber to the regulator chamber, and allowing the reverse flow of brake fluid when the pressure in the regulator chamber has become equal to or more than the pressure in the counter-force pressure chamber by a first predetermined pressure. And, a second check valve is provided for normally preventing the flow of brake fluid from the regulator chamber to the counter-force pressure chamber, and allowing the reverse flow of brake fluid when the pressure in the counter-force pressure chamber has become equal to or more than the pressure in the regulator chamber by a second predetermined pressure, which is set to be greater than the first predetermined pressure.

This application claims priority under 35 U.S.C. Sec. 119 to No.2002-268800 filed in Japan on Sep. 13, 2002, the entire content of which is herein incorporated by reference.

### BACKGROUND OF THE INVENTION

1. Field of the invention

The present invention relates to a hydraulic brake apparatus for supplying a hydraulic brake pressure to each wheel brake cylinder mounted on each wheel of a vehicle, and more particularly to the apparatus which is provided with a hydraulic pressure assisting device.

2. Description of the Related Arts

As for a hydraulic brake apparatus provided with a hydraulic pressure assisting device, it is disclosed in the U.S. Pat. No.6,089,676, which corresponds to Japanese Patent Laid-open Publication No. 11-115728. The apparatus includes a cylinder body mounted on the vehicle, a reservoir for storing brake fluid, a master cylinder having a master piston slidably received in the cylinder body to define a pressure chamber ahead of the master piston and a power chamber behind the master piston, so that the brake fluid in the reservoir is fed into the pressure chamber, and the master piston is moved in response to operation of the manually operated braking member to discharge hydraulic brake pressure from the pressure chamber. An auxiliary pressure source is provided for pressurizing the brake fluid in the reservoir to discharge power pressure of a predetermined value. A control piston is slidably disposed in the cylinder body ahead of the master piston to be movable in response to movement of the master piston, so that the control piston defines ahead thereof a regulator chamber, and exposes a rear end thereof to the pressure chamber. The power chamber is communicated with the regulator chamber to assist forward movement of the master piston. A pressure increase valve device is provided for communicating the regulator chamber with the auxiliary pressure source or cutting off the communication therebetween in response to movement of the control piston. Also, a pressure decrease valve device is provided for communicating the regulator chamber with the reservoir or cutting off the communication therebetween in response to movement of the control piston. And, at least the power chamber is communicated with the regulator chamber, to assist the master piston.

In the United states Patent as described above, the U.S. Pat. No. 3,928,970 and Japanese Patent Laid-open Publication Nos. 9-24818 and 9-24819 are cited as prior arts. According to these Publications, it has been described that it is possible to increase the braking force in case of an emergency braking operation, whereas the apparatuses as disclosed in the Publications provide only two kinds of characteristics of the master cylinder pressure to braking input force for a normal braking operation and the emergency braking operation. Therefore, it has been concluded that it is impossible to maintain a certain characteristic of a vehicle deceleration to the braking input force, by varying the characteristic of the master cylinder pressure to the braking input force in response to variations of load to the vehicle and coefficient of friction of a brake pad, for example, to improve a braking property. Also, in the U.S. Pat. No. 3,928,970 as described above, it has been stated that the apparatus having the inlet valve and exhaust valve is not adapted to increase the braking force in case of the emergency braking operation, so that it is difficult to improve the braking property of the apparatus. Then, it has been proposed to provide a hydraulic brake apparatus for a vehicle which can vary the characteristic of the master cylinder pressure to the braking input force appropriately.

As means for solving the problem, therefore, the hydraulic brake apparatus is provided with a counter-force control device for producing counter-force in response to the pressure generated in one of the pressure chamber, the auxiliary pressure source and the power chamber, and applying the counter-force to the pressure increase valve device and the pressure decrease valve device to be moved in a direction opposite to a direction thereof moved by the control piston, a pressure control valve device for continuously varying the pressure in the counter-force pressure chamber to be regulated into a predetermined pressure, and an electronic control unit for controlling the pressure control valve device.

According to the apparatus as disclosed in the U.S. Pat. No. 6,089,676, the characteristic of the master cylinder pressure to the braking input force can be controlled properly. However, the apparatus requires the pressure control valve device and the electronic control unit for controlling it, to result in an expensive apparatus. In addition, when the braking force has been released from a high depressing force state where a large braking input force (depressing force) was applied, a large hysteresis is caused by increase and decrease of the braking input force. Therefore, it is not so easy to perform a braking control, as will be described later in detail with reference to FIGS.7-11.

### SUMMARY OF THE INVENTION

Accordingly, it is an object of the present invention to provide a hydraulic brake apparatus for a vehicle, which is provided with a hydraulic pressure assisting device, and which is capable of reducing a hysteresis caused by increase and decrease of braking input force as small as possible, to achieve an appropriate braking control.

In order to accomplish the above and other objects, a hydraulic brake apparatus is provided for applying braking force to each wheel of a vehicle in response to depression of a manually operated braking member. The apparatus includes a cylinder body mountable on the vehicle, a reservoir for storing brake fluid, a master cylinder having a master piston slidably received in the cylinder body to define a pressure chamber ahead of the master piston and a power chamber behind the master piston, so that the brake fluid in the reservoir is fed into the pressure chamber, and the master piston is moved in response to operation of the manually operated braking member to discharge hydraulic brake pressure from the pressure chamber. An auxiliary pressure source is provided for pressurizing the brake fluid in the reservoir to discharge power pressure of a predetermined value. A control piston is slidably disposed in the cylinder body ahead of the master piston to be movable in response to movement of the master piston, so that the control piston defines ahead thereof a regulator chamber, and exposes a rear end thereof to the pressure chamber. The power chamber is communicated with the regulator chamber to assist forward movement of the master piston. A pressure increase valve device is provided for communicating the regulator chamber with the auxiliary pressure source or cutting off the communication therebetween in response to movement of the control piston. Also, a pressure decrease valve device is provided for communicating the regulator chamber with the reservoir or cutting off the communication therebetween in response to movement of the control piston. A counter-force device is provided for defining a counter-force pressure chamber communicating with the regulator chamber, so that the pressure generated in the auxiliary pressure source is supplied to the counter-force pressure chamber through the pressure increase valve device to move the pressure increase valve device and the pressure decrease valve device in a direction opposite to a direction thereof moved by the control piston. The apparatus further includes a first valve device which normally prevents the flow of brake fluid from the counter-force pressure chamber to the regulator chamber, and allows the flow of brake fluid from the regulator chamber to the counter-force pressure chamber when the pressure in the regulator chamber has become equal to or more than the pressure in the counter-force pressure chamber by a first predetermined pressure, and a second valve device which normally prevents the flow of brake fluid from the regulator chamber to the counter-force pressure chamber, and allows the flow of brake fluid from the counter-force pressure chamber to the regulator chamber when the pressure in the counter-force pressure chamber has become equal to or more than the pressure in the regulator chamber by a second predetermined pressure, which is set to be greater than the first predetermined pressure.

In the hydraulic brake apparatus, the first predetermined pressure for the first valve device may be set to be approximately zero.

As for each of the first and second valve devices, may be employed a check valve which is disposed between the counter-force pressure chamber and the regulator chamber.

Preferably, the cylinder body may be formed with a recess which opens to outside thereof and communicates with the regulator chamber and the counter-force pressure chamber, so that the first and second valve devices may be disposed in the recess.

### BRIEF DESCRIPTION OF THE DRAWINGS

The above stated objects and following description will become readily apparent with reference to the accompanying drawings, wherein like reference numerals denote like elements, and in which:

FIG. 1 is a sectional view of a hydraulic brake apparatus according to an embodiment of the present invention;

FIG. 2 is an enlarged sectional view of a front section of a hydraulic brake apparatus according to an embodiment of the present invention;

FIG. 3 is a schematic sectional view of a hydraulic brake apparatus, in its initial state that a brake pedal has not been depressed, according to an embodiment of the present invention;

FIG. 4 is a schematic sectional view of a hydraulic brake apparatus, in such a state that a brake pedal has been depressed with a high depressing force, according to an embodiment of the present invention;

FIG. 5 is a schematic sectional view of a hydraulic brake apparatus, in such a state that braking force has been released from such a state that a brake pedal was depressed with a high depressing force, according to an embodiment of the present invention;

FIG. 6 is a diagram showing a characteristic of hydraulic brake pressure, according to an embodiment of the present invention;

FIG. 7 is a diagram showing a characteristic of hydraulic brake pressure, according to a prior hydraulic brake apparatus;

FIG. 8 is a schematic sectional view of a hydraulic brake apparatus, in such an initial state that a brake pedal has not been depressed, according to a prior hydraulic brake apparatus;

FIG. 9 is a schematic sectional view of a hydraulic brake apparatus, in such a state that a brake pedal has been depressed with a low depressing force, according to a prior hydraulic brake apparatus;

FIG. 10 is a schematic sectional view of a hydraulic brake apparatus, in such a state that a brake pedal has been depressed with a high depressing force, according to a prior hydraulic brake apparatus; and

FIG. 11 is a schematic sectional view of a hydraulic brake apparatus, in such a state that braking force has been released from such a state that a brake pedal was depressed with a high depressing force, according to a prior hydraulic brake apparatus.

### DESCRIPTION OF THE PREFERRED EMBODIMENTS

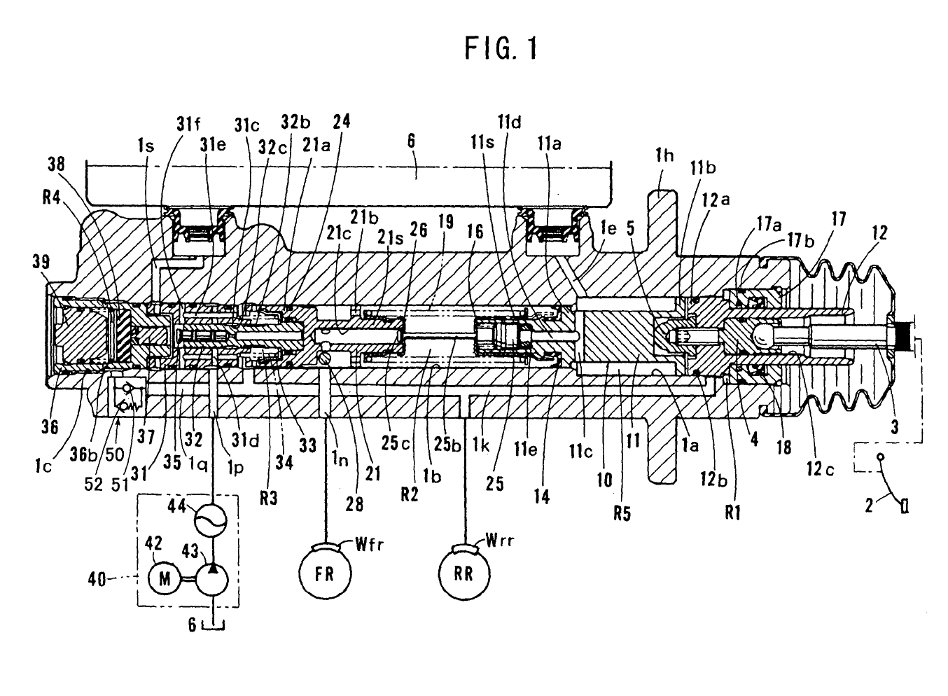

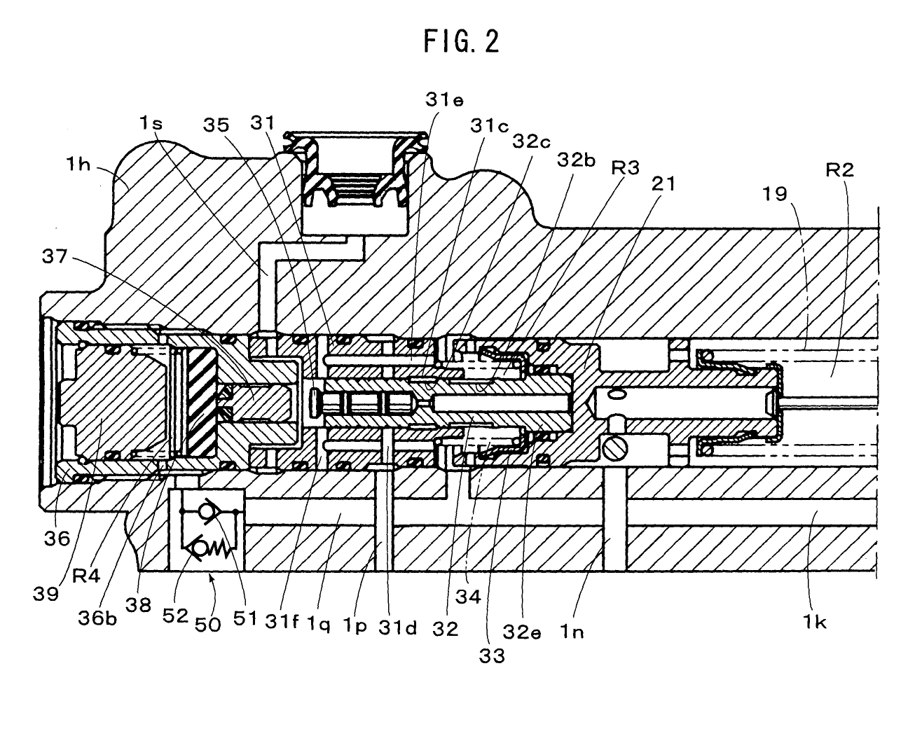

Referring to FIG. 1, there is illustrated a hydraulic brake apparatus for a vehicle according to an embodiment of the present invention, which includes a cylinder body 1h provided with a master cylinder section and a regulator section. FIG. 2 illustrates an enlarged view of the regulator section constituting a pressure increase valve device and a pressure decrease valve device. The regulator section is formed in the cylinder body 1h at its front portion to the vehicle (left in FIG. 1), and the master cylinder section is formed in the cylinder body 1h at its rear portion, and a brake pedal 2 is disposed behind it to serve as a manually operated braking member according to the present invention. When depressing force is applied to the brake pedal 2, the force is transmitted as braking input force to the master cylinder section through a push rod 3 and an input member 4. In response to the braking input force, the hydraulic brake pressure generated from the master cylinder section is supplied to wheel brake cylinders Wfr, Wfl which are operatively mounted on front right and left wheels FR, FL, and the hydraulic brake pressure generated from the regulator section is supplied to wheel brake cylinders Wrr, Wrl which are operatively mounted on rear right and left wheels RR, RL, respectively (FIG. 1 shows only wheel brake cylinders Wfr, Wrr which are operatively mounted on a front right wheel FR and a rear right wheel RR, respectively).

In the cylinder body 1h, there is formed a stepped bore which includes bores 1a, 1b, 1c having different inner diameters from one another, and in which a master piston 10 and a control piston 21 are received to define a pressure chamber R2 between the master piston 10 and control piston 21. The rear end of the bore 1a is communicated with a boosting chamber or power chamber R1. The control piston 21 is fluid-tightly and slidably fitted into the bore 1b. The master piston 10 includes two pistons 11, 12, end portions of which are received in the bore 1b and the bore la, respectively. That is, a land portion 11a of a small diameter is formed around an outer surface of a front portion of the piston 11, and a land portion 11b of a large diameter is formed at a rear portion of the piston 11 with a certain distance axially apart from the land portion 11a. The land portion 11a retains an annular cup-like seal member 14 to be fluid-tightly and slidably fitted into the bore 1b, while the land portion 11b is slidably fitted into the bore la to abut on the piston 12.

The piston 11 has a cylindrical support portion 11s extending from the end of the land portion 11a and a recess 11e formed axially in the support portion 11s. Furthermore, the piston 11 has a radial passage 11c, and an axial passage 11d communicated therewith and opened to communicate with the recess 11e in which a valve member 25 is slidably received. A retainer 16 is mounted on the support portion 11s to prevent the valve member 25 from moving toward the control piston 21. One end of the valve member 25 is covered by a member made of resilient material such as rubber, which can abut on the passage 11d to shut off the same. At the other end of the valve member 25, a rod 25b is formed to be integral with the valve member 25, and an engaging portion 25c is formed at the front end of the rod 25b. Accordingly, a fluid chamber R5, which is communicated with a reservoir 6 through a passage 1e, can be communicated with the pressure chamber R2 through the passages 11c and 11d.

Behind the piston 11 is disposed the piston 12 having a land portion 12a formed around its outer surface at its front portion and provided with an annular seal member 12b to be fluid-tightly and slidably received in the bore 1a. Thus, the power chamber R1 and the fluid chamber R5 are separated by the seal member 12b. At the rear end of the piston 12 is formed a recess 12c in which the input member 4 is received, and the front end of the piston 12 is screwed with a contact member 5. The piston 12 is arranged such that its front end faces the rear end of the piston 11, and that the depressing force of the brake pedal 2 can be transmitted to the piston 11 through the input member 4 and the contact member 5. A main body of the piston 12 is supported by a cylindrical sleeve 17, the inner surface and outer surface of which are formed with annular grooves, and also an annular groove on the inner surface which is axially remote from them by a certain distance. Annular seal members 17a, 17b and 18 are received in those grooves to ensure a sealing property against the power chamber R1. The piston 11 and piston 12 may be formed in a body.

In the front portion of the cylinder body 1h, the regulator section with a spool valve mechanism is formed, and connected to an auxiliary pressure source 40 for discharging the power pressure. The regulator section is adapted to regulate the power pressure to produce a regulated pressure. The auxiliary pressure source 40 includes a hydraulic pressure pump 43 which is driven by an electric motor 42, and its inlet is connected to the reservoir 6 and its outlet is connected to the accumulator 44, through which the power pressure is supplied to a passage 31d via a passage 1p. The control piston 21 has a pair of land portions 21a, 21b which are formed around its outer surface with a certain distance apart axially between them, and received in the bore 1c. An annular seal member 24 is disposed only in the front land portion 21a, and the front space and rear space of the rear land portion 21b are communicated with each other. Thus, the pressure chamber R2 and a regulator chamber R3 which will be described later are separated by the seal member 24, and the pressure chamber R2 is defined between the seal member 24 and the seal member 14 mounted on the land portion 11a of the piston 11.

As shown in FIG. 1, the control piston 21 has a passage 21c which is formed radially and extends axially to be opened at the rear end. An engaging pin 28 is fixed to the cylinder body 1h at the rear end of the land portion 21a, so that the control piston 21 is allowed to move forward, but restrained from moving backward, i.e., the control piston 21 is prevented from moving beyond the pin 28 toward the master piston 10. The control piston 21 has a cylindrical support portion 21s integral therewith to enclose the passage 21c. An engaging portion 25c is formed on the valve member 25, and disposed in the support portion 21s. A retainer 26 is mounted on the support portion 21s, and engaged with the engaging portion 25c to restrain the valve member 25 from moving toward the master piston 10. At the front end of the control piston 21 is formed a recess in which a rear end portion of a spool 32 is held as will be described later.

A cylindrical sleeve 31 and a sleeve-like adjusting member 36 are received in the stepped bore 1c which is communicated with the bore 1b. The regulator chamber R3 is defined between the sleeve 31 and the control piston 21. The sleeve 31 and adjusting member 36 have a plurality of annular grooves formed around its outer periphery, and annular seal members are received in the grooves, respectively. Between the neighboring seal members are formed radial passages 31d, 31f, and a radial passage 36b is formed in the adjusting member 36. The spool 32 is slidably received in the hollow portion of the sleeve 31, and arranged to shut off the opening portion of the passage 31f in accordance with forward movement of the spool 32. The sleeve 31 has a passage 31e, one end of which is communicated with the passage 31f, and the other end of which is communicated with the regulator chamber R3. When the passage 31f is opened, the regulator chamber R3 is communicated with a passage is through the passages 31e and 31f. The passage 31d is communicated with the auxiliary pressure source 40 through the passage 1p, while it is closed by the outer peripheral surface of the spool 32 when the spool 32 is placed at a position as shown in FIG. 1. Furthermore, an annular groove 31c is formed on the inner peripheral surface of the sleeve 31 at the rear of the passage 31d. The passage 36b is communicated with passages 1q and 1k, which are communicated with each other.

A plunger 35 is fitted into the front end of the spool 32 to extend axially therefrom. The rear end of the spool 32 is placed in the regulator chamber R3 and engaged with the control piston 21. A retainer 33 is supported in the recess of the control piston 21, and a spring 34 is mounted between the sleeve 31 and the retainer 33 to urge the spool 32 to abut on the control piston 21. When the control piston 21 is placed in its initial position, i.e., rearmost position, the opening portion of the passage 31f is not closed by the spool 32, but the regulator chamber R3 is communicated with the reservoir 6 through the passages 31e, 31f of the sleeve 31 and the passage 1s, to be filled with the brake fluid under atmospheric pressure. An annular groove 32b is formed on a predetermined area of the outer surface of the spool 32 along the axis of the spool 32, such that the rear end of the sleeve 31 is positioned in the center of the area when the spool 32 is placed at the rearmost position thereof. And, an annular groove 32c is formed on a predetermined area of the outer surface of the spool 32 with a predetermined distance away from the groove 32b to face the groove 31c of the sleeve 31.

Accordingly, at the position of the spool 32 as shown in FIG. 1, the pressure in the regulator chamber R3 is communicated with the reservoir 6 through the passages 31e, 31f and the passage 1s to be under atmospheric pressure. When the spool 32 is moved forward in response to movement of the control piston 21, the passage 31f of the sleeve 31 is shut off, and in turn the passage 31d of the sleeve 31 faces the groove 32c of the spool 32 and at the same time the groove 31c faces the groove 32b, so that the regulator chamber R3 is communicated with the auxiliary pressure source 40, from which the power pressure is supplied into the regulator chamber R3 to increase the pressure therein.

The adjusting member 36 has a hollow portion defined therein to provide a stepped bore, whose small diameter portion is adapted to receive a transmitting member 37 to be movable along the axis of the member 36, with its rear end surface facing the front end surface of the plunger 35. A resilient member 38 made by rubber for example, is disposed in a large diameter portion of the stepped bore in the member 36 to abut on the front end surface of the transmitting member 37. According to the present embodiment, the transmitting member 37 is provided with a member in the shape of a truncated cone. Instead, the front end portion of the transmitting member 37 may be shaped into the truncated cone. A plug 39 is fitted into the front end of the hollow portion of the adjusting member 36 to define a counter-force pressure chamber R4 between the plug 39 and the resilient member 38. The counter-force pressure chamber R4 is communicated with the regulator chamber R3 through a check valve device 50 and the passages 1q and 36b. Thus, the counter-force device according to the present invention is constituted. The regulator chamber R3 is communicated with the power chamber R1 through the passage 1k. The pressure chamber R2 is communicated with the wheel cylinder Wfr through a passage 1n, while the power chamber R1 (and the regulator chamber R3) is communicated with the wheel cylinder Wrr through the passage 1k.

The check valve device 50 constitutes the first and second valve devices according to the present invention. The first valve device is constituted by a check valve 51 which normally prevents the flow of brake fluid from the counter-force pressure chamber R4 to the regulator chamber R3, and allows the flow of brake fluid from the regulator chamber R3 to the counter-force pressure chamber R4 when the pressure in the regulator chamber R3 has become equal to or more than the pressure in the counter-force pressure chamber R4 by a first predetermined pressure (e.g., approximately zero), to provide a check valve whose valve opening pressure is substantially zero, for example. And, the second valve device is constituted by a check valve 52 which normally prevents the flow of brake fluid from the regulator chamber R3 to the counter-force pressure chamber R4, and allows the flow of brake fluid from the counter-force pressure chamber R4 to the regulator chamber R3 when the pressure in the counter-force pressure chamber R4 has become equal to or more than the pressure in the regulator chamber R3 by a second predetermined pressure, which is set to be greater than the first predetermined pressure (i.e., set as a predetermined valve opening pressure). According to the present embodiment, there is formed in the cylinder body 1h, a recess which opens outside of the cylinder body 1h, and which communicates with the regulator chamber R3 and counter-force pressure chamber R4. And, the check valve device 50 is adapted to be fitted into the recess of the cylinder body 1h. Therefore, the check valve device 50 can be easily mounted on a conventional hydraulic brake apparatus, only with a slight change made thereto.

FIG. 2 enlarges the regulator section which is provided with the spool valve mechanism as described above, and which constitutes the pressure increase valve device and pressure increase valve device. The spool 32 is shaped into a stepped cylindrical member having a small diameter main portion and a large diameter portion 32e which is urged to abut on the control piston 21 by the spring 34 through the retainer 33 as described before. When the pressure in the regulator chamber R3 is increased, the large diameter portion 32e is pressed to the control piston 21. The sleeve 31 is a stepped cylindrical member having a large diameter portion at its front end and a small diameter portion at its rear end, with a passage 31d formed therebetween. When the power pressure is supplied from the auxiliary pressure source 40 (FIG. 1) through the passage 31d to a space between the large diameter portion and small diameter portion of the sleeve 31, and between the outer surface of the sleeve 31 and the inner surface of the cylinder bore, the sleeve 31 is forced to make the end face of its large diameter portion to abut on the adjusting member 36. As described above, the adjusting member 36 is the cylindrical member with the transmitting member 37 slidably received in its hollow portion. The resilient member 38 is held to abut on the front end surface of the transmitting member 37, and the rear end of the transmitting member 37 is arranged to face the plunger 35 mounted on the front end of the spool 32. When the hydraulic pressure is supplied into the counter-force pressure chamber R4 through the passage 1q and applied to the resilient member 38, the spool 32 is moved rearward to increase the opening area of the passage 31f, thereby to decrease the regulated pressure in the regulator chamber R3.

Next will be explained an overall operation of the hydraulic brake apparatus as constituted above. FIGS. 1 and 2 show a state of the apparatus when the brake pedal 2 is not depressed. If the brake pedal 2 is depressed to push the pistons 11, 12 forward (leftward in FIG. 1) through the push rod 3, transmitting member 4 and contact member 5, the valve member 25 will abut on the piston 11 to close the passage lid by the resilient member of the valve member 25, so that the communication between the pressure chamber R2 and the fluid chamber R5 will be cut off to provide a closed state. In the case where the communication between the pressure chamber R2 and the fluid chamber R5 is cut off, if the pistons 11, 12 are moved in response to depression of the brake pedal 2, these will move together in a body, because the control piston 21 is held as shown in FIG. 1 by the spring 19. As a result, the passage 31f is closed by the spool 32, which is supported in the control piston 21, to cut off the communication with the reservoir 6. At the same time, the power pressure is supplied from the auxiliary pressure source 40 to the regulator chamber R3 through the passage 1p, passage 31d, annular grooves 31c and 32c, and then introduced into the regulator chamber R3 through the annular groove 32b, to discharge the regulated pressure which is supplied to the counter-force pressure chamber R4 through the passage 1q (and the check valve 51), and further to the power chamber R1 through the passage 1k. By the pressure in the power chamber R1, the pistons 11, 12 is assisted to move forward, thereby to compress further the pressure chamber R2, and supply the hydraulic brake pressure, i.e., master cylinder pressure to the wheel brake cylinder Wfr through the passage 1n, and the regulated pressure is supplied from the power chamber R1 to the wheel brake cylinder Wrr through the passage 1k.

Supposing that the pressure equal to the regulated pressure is supplied to the counter-force pressure chamber R4, until the force produced by the pressure in the counter-force pressure chamber R4 is transmitted to the plunger 35 through the resilient member 38 and transmitting member 37, if the force applied to the control piston 21 by the regulated pressure in the regulator chamber R3 exceeds the force applied to the control piston 21 by the master cylinder pressure in the pressure chamber R2, the control piston 21 will be moved rearward to open the passage 31f and communicate with the reservoir 6, so that the pressure in the regulator chamber R3 will be reduced. When the relationship between the forces applied to the control piston 21 is reversed, the control piston 21 is moved forward to close the passage 31f and communicate the regulator chamber R3 with the auxiliary pressure source 40 through the passage 31d and etc., so that the pressure in the regulator chamber R3 is increased.

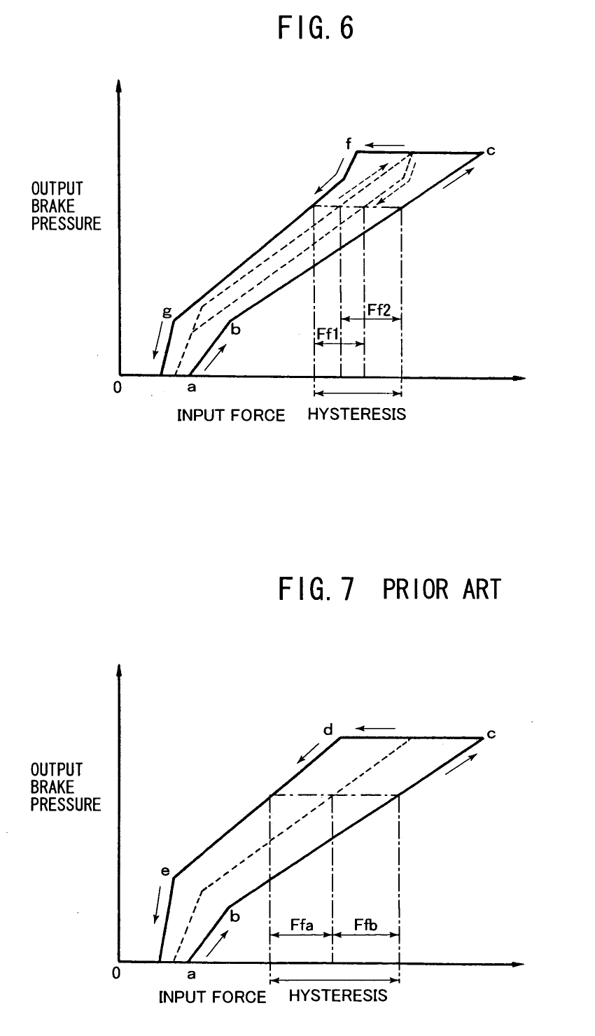

With the above-described movement of the spool 32 repeated in response to movement of the control piston 21, the force applied to the control piston 21 by the regulated pressure is regulated to be equal to the force applied to the control piston 21 by the master cylinder pressure. Until the force produced by the regulated pressure in the counter-force pressure chamber R4 is transmitted to the spool 32 through the plunger 35, with the resilient member 38 deformed to press the transmitting member 37, the regulated pressure is output substantially in proportion to the master cylinder pressure. Consequently, an initial state of the hydraulic brake pressure characteristic can be obtained to cover a zone from a position “a” to a position “b” in the hydraulic brake pressure characteristic of the present embodiment in FIG. 6, as will be described later in detail.

If the regulated pressure is increased further to increase the pressure supplied into the counter-force pressure chamber R4, and a middle portion of the resilient member 38 is deformed to be displaced rearward, then the transmitting member 37 abuts on the plunger 35 to push the spool 32 rearward, the opening area of the passage 31f will be increased. Accordingly, the regulated pressure in the regulator chamber R3 is reduced to provide a hydraulic brake pressure characteristic which is substantially in proportion to the master cylinder pressure, but which has a smaller increasing gradient than that of the initial brake pressure characteristic (from the position “a” to “b” in FIG. 6) of the master cylinder pressure to the braking input force, as shown in a zone from the position “b” to “c” in FIG. 6. In this case, however, the resilient member 38, transmitting member 37, plunger 35, spool 32 and control piston 21 are eventually connected together, so that a component of the force, which is applied to the resilient member 38 by the regulated pressure supplied to the counter-force pressure chamber R4, is directly (mechanically) transmitted to the control piston 21 through the plunger 35 and spool 32, to act as the counter-force, for which the braking input force will be required to compensate.

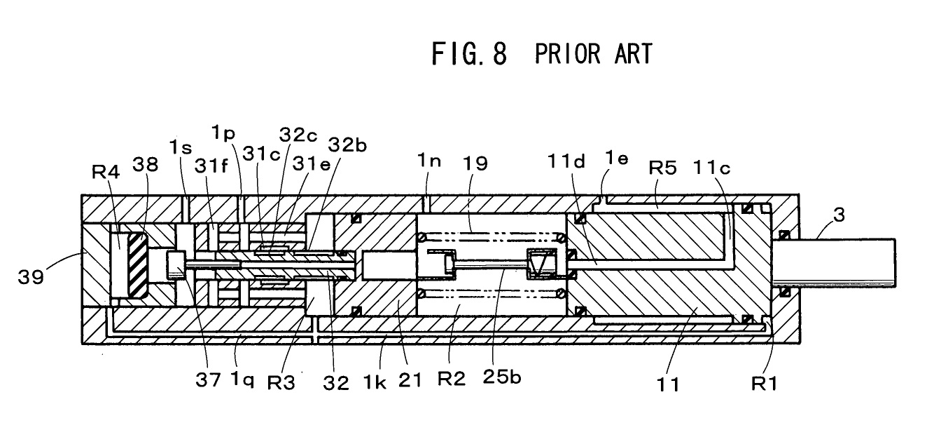

FIG. 6 shows a hydraulic brake pressure characteristic according to the present embodiment, showing a variation of brake pressure output to the wheel cylinders Wfr and Wrr in response to the input force (load) applied by operation of the brake pedal 2. In FIG. 6, a dotted line indicates a desired (target) pressure characteristic, and a solid line indicates the actual characteristic with a hysteresis added by frictional force between sliding parts. FIG. 7 shows a hydraulic brake pressure characteristic according to the prior apparatus as shown in FIGS. 8-11, wherein the dotted line indicates the desired (target) pressure characteristic of the prior apparatus, and the solid line indicates the actual characteristic with the hysteresis added by frictional force between sliding parts of the prior apparatus. FIGS. 8-11 are schematic illustrations of the hydraulic brake apparatus as shown in the U.S. Pat. No. 6,089,676, wherein substantially the same parts as those indicated in the apparatus of the present embodiment shown in FIGS. 1 and 2 are indicated by the same reference numerals to omit the detailed explanation of them, and wherein the check valve device 50 as shown in FIGS. 1 and 2 does not exist. Furthermore, the piston 12 in the United States Patent as described above has been omitted in FIGS. 8-11, so that only the piston 11 appears.

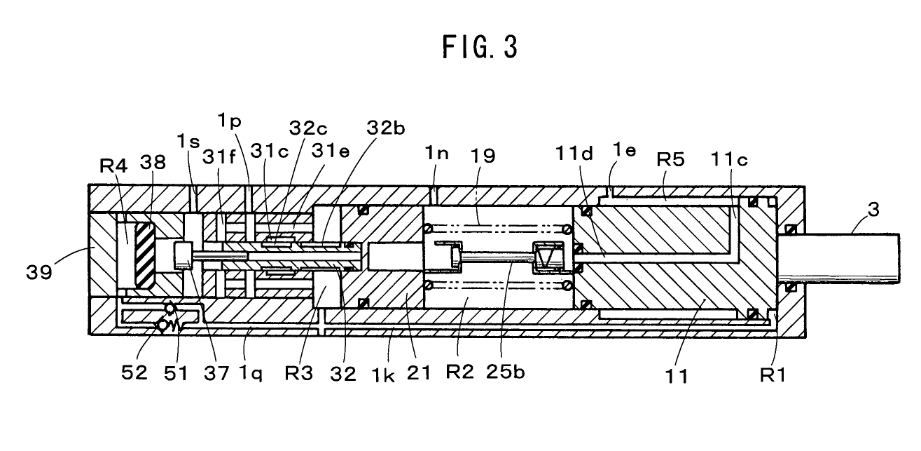

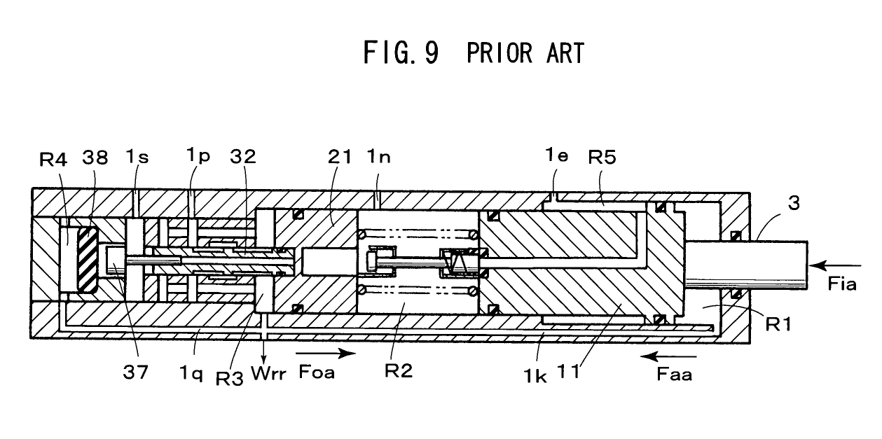

Hereinafter, the operation of the prior apparatus is explained with reference to FIGS. 7-11 at the outset, and then the operation of the present embodiment will be explained with reference to FIGS. 3-6. FIG. 8 shows an initial state that a brake pedal (not shown) has not been depressed, so that it is in the same state as the state shown in FIGS. 1 and 2. When the brake pedal is depressed in that state, the depressing force (input force) (Fia) is applied to the piston 11 through the push rod 3. As a result, the piston 11 is moved forward (leftward in FIG. 9), and the piston 11 is moved together with the control piston 21 in a body, with the communication between the pressure chamber R2 and the fluid chamber R5 being cut off. In response to movement of the control piston 21, the spool 32 is activated, the regulated pressure is supplied to the regulator chamber R3, and supplied to the power chamber R1 through the passage 1k, to apply an assisting force (Faa). Consequently, the piston 11 is assisted to move forward, and the counter-force (Foa) is applied to the control piston 21 by the regulated pressure, to compress the pressure chamber R2, so that the master cylinder pressure is output from the passage 1n, and the regulated pressure is output through the passage 1k. At the same time, the regulated pressure is supplied to the counter-force pressure chamber R4 through the passage 1q. However, as the depressing force (input force Fia) is small, i.e., at the time of low depressing force, and the regulated pressure is low, the resilient member 38 has not been in such a state to push the transmitting member 37.

When the braking input force is given further to apply a large depressing force (input force Fib), i.e., at the time of high depressing force, the regulated pressure in the regulator chamber R3 is increased, so that the assisting force (Fab) is increased, and the counter-force (Fob) applied to the control piston 21 is increased, whereby the output brake pressure will be increased. And, as the regulated pressure supplied to the counter-force pressure chamber R4 is increased as well, the resilient member 38 is deformed to push the transmitting member 37, and the counter-force (Frb) produced by the pressure in the counter-force pressure chamber R4 is applied to the control piston 21 to increase the counter-force (Fob) of the control piston 21, so that the output brake pressure will be increased. In this case, however, the increasing gradient of pressure is small (gentle), comparing with the increasing gradient of pressure in the initial state as shown in FIG. 9 (at the time of low depressing force).

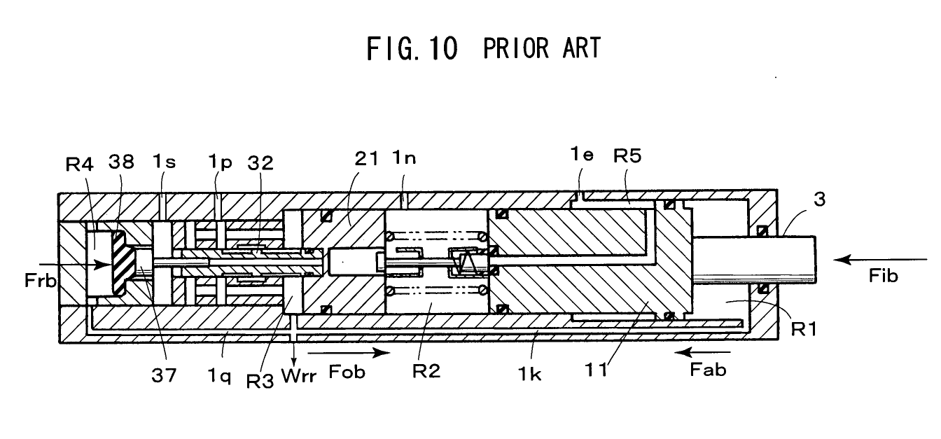

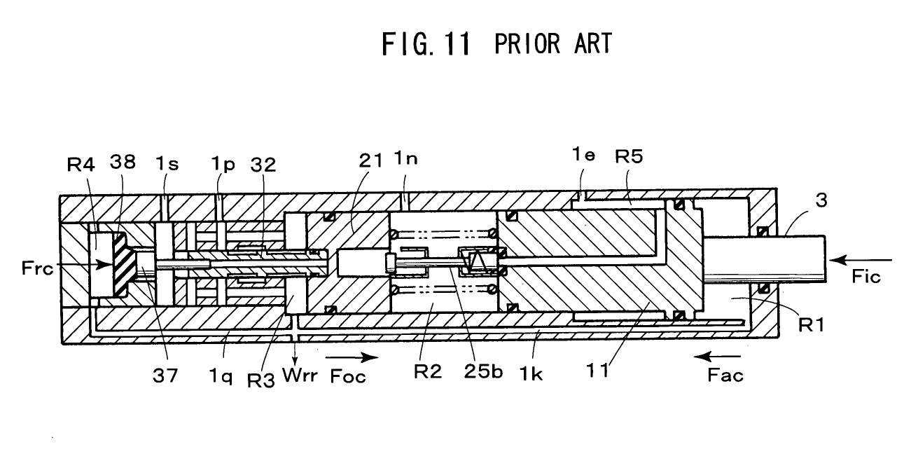

Next, when the braking input force is reduced from the high depressing force state as shown in FIG. 10, to provide the depressing force (input force Fic) as shown in FIG. 11, the regulated pressure in the regulator chamber R3 is reduced, so that the assisting force (Fac) is decreased, and the counter-force (Foc) applied to the control piston 21 is decreased as well, whereby the output brake pressure will be decreased. And, as the regulated pressure in the counter-force pressure chamber R4 is decreased, the counter-force chamber R4 is decreased, so that the output brake pressure will be decreased from the position “c” to “d” and further to the position “e”, as indicated by arrows in FIG. 7. In this case, as for the desired pressure characteristic as indicated by the dotted line in FIG. 7, a large hysteresis will be caused as indicated by the one-dotted chain line in FIG. 7, by the frictional forces (Ffa and Ffb in FIG. 7) between the sliding parts, i.e., between the cylinder body 1h and the push rod 3, piston 11, control piston 21 or the like. Particularly, according to the prior apparatus, even if the braking input force is reduced from the high depressing force state as shown in FIG. 10, the frictional forces between the sliding parts as described above will prevent the control piston 21 from being returned. If the depressing force (Fic) is released until the counter-force (Foc) will overcome the frictional forces, e.g., reduced from the position “c” to the position “d” in FIG. 7, the control piston 21 will be returned, and the pressure in the regulator chamber R3 will be decreased, whereby the output brake pressure will be decreased. Thus, as a large hysteresis is caused by the increase and decrease of the braking input force, the brake pressure control will not be made easily.

In contrast, according to the present embodiment, the apparatus operates as shown in FIGS. 3-5, so that the brake pressure characteristic as shown in FIG. 6 can be obtained. FIG. 3 shows the initial state that the brake pedal (not shown) has not been depressed, so that it is in the same state as the state shown in FIGS. 1 and 2. When the brake pedal is depressed in that state, a large depressing force (input force) (Fi1) is applied, i.e., at the time of large depressing force, the regulated pressure in the regulator chamber R3 is increased, so that the assisting force (Fa1) is increased, and the counter-force (Fo1) of the control piston 21 is increased, whereby the output brake pressure will be increased. And also, the regulated pressure supplied to the counter-force pressure chamber R4 through the check valve 50 with its valve opening pressure set to be zero is increased. Consequently, the resilient member 38 is deformed to push the transmitting member 37, and the counter-force (Fr1) produced by the pressure in the counter-force pressure chamber R4 is applied to the control piston 21 to increase the counter-force (Fo1), whereby the output brake pressure will be increased.

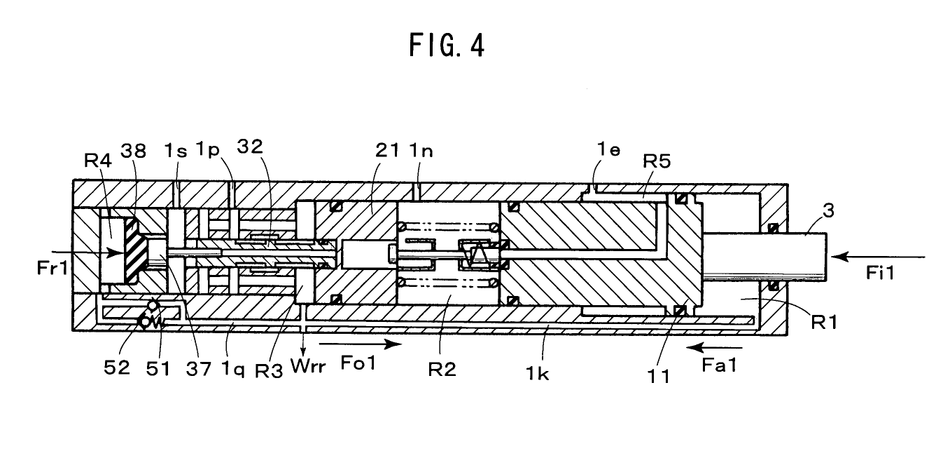

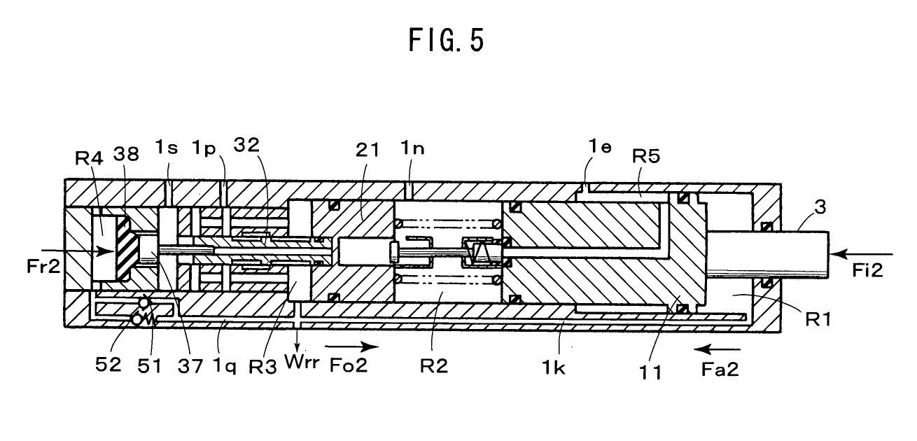

When the braking input force is reduced from the high depressing force state as shown in FIG. 4, to provide the depressing force (input force Fi2) as shown in FIG. 5, the regulated pressure in the regulator chamber R3 is reduced, so that the assisting force (Fa2) is decreased, and the counter-force (Fo2) applied to the control piston 21 is decreased as well, whereby the output brake pressure will be decreased. And, as the brake fluid in the counter-force pressure chamber R4 is returned to the regulator chamber R3 through the check valve 52 with its valve opening pressure set to be high, the reduction of the counter-force (Fr2) caused by the reduction in pressure in the counter-force pressure chamber R4 will be delayed (slowed) by the amount of the valve opening pressure of the check valve 52. In other words, the desired pressure. characteristic as indicated by the dotted arrows in FIG. 6 has been set, according to the present embodiment. Even if the frictional forces (Ff1 and Ff2 in FIG. 6) between the sliding parts as described above were added to the desired pressure characteristic in FIG. 6, the input force (braking operation force) will be shifted from the position “c” to “f” and further to the position “g”. As indicated by one-dotted chain lines in FIG. 6, therefore, the hysteresis will be reduced much smaller than that as shown in FIG. 7. As a result, a good follow-up property to the increase and decrease of the braking input force can be obtained, thereby to achieve an appropriate braking control.

It should be apparent to one skilled in the art that the above-described embodiments are merely illustrative of but a few of the many possible specific embodiments of the present invention. Numerous and various other arrangements can be readily devised by those skilled in the art without departing from the spirit and scope of the invention as defined in the following claims.

What is claimed is:

1. A hydraulic brake apparatus for applying braking force to each wheel of a vehicle in response to depression of a manually operated braking member comprising:
a cylinder body mountable on said vehicle;
a reservoir for storing brake fluid;
a master cylinder having a master piston slidably received in said cylinder body to define a pressure chamber ahead of said master piston and a power chamber behind said master piston, the brake fluid in said reservoir being fed into said pressure chamber, and said master piston being moved in response to operation of said manually operated braking member to discharge hydraulic brake pressure from said pressure chamber;
an auxiliary pressure source for pressurizing the brake fluid in said reservoir to discharge power pressure of a predetermined value;
a control piston slidably disposed in said cylinder body ahead of said master piston to be movable in response to movement of said master piston, said control piston defining ahead thereof a regulator chamber, and exposing a rear end thereof to said pressure chamber, said power chamber being communicated with said regulator chamber to assist forward movement of said master piston;
pressure increase valve means for communicating said regulator chamber with said auxiliary pressure source or cutting off the communication therebetween in response to movement of said control piston;
pressure decrease valve means for communicating said regulator chamber with said reservoir or cutting off the communication therebetween in response to movement of said control piston;
counter-force means for defining a counter-force pressure chamber communicating with said regulator chamber, with the pressure generated in said auxiliary pressure source being supplied to said counter-force pressure chamber through said pressure increase valve means to move said pressure increase valve means and said pressure decrease valve means in a direction opposite to a direction thereof moved by said control piston;
first valve means for normally preventing the flow of brake fluid from said counter-force pressure chamber to said regulator chamber, and allowing the flow of brake fluid from said regulator chamber to said counter-force pressure chamber when the pressure in said regulator chamber has become equal to or more than the pressure in said counter-force pressure chamber by a first predetermined pressure; and
second valve means for normally preventing the flow of brake fluid from said regulator chamber to said counter-force pressure chamber, and allowing the flow of brake fluid from said counter-force pressure chamber to said regulator chamber when the pressure in said counter-force pressure chamber has become equal to or more than the pressure in said regulator chamber by a second predetermined pressure, which is set to be greater than the first predetermined pressure.

2. A hydraulic brake apparatus as set forth in claim 1, wherein the first predetermined pressure is set to be approximately zero.

3. A hydraulic brake apparatus as set forth in claim 1, wherein said first valve means includes a first check valve disposed between said counter-force pressure chamber and said regulator chamber for normally preventing the flow of brake fluid from said counter-force pressure chamber to said regulator chamber, and allowing the flow of brake fluid from said regulator chamber to said counter-force pressure chamber when the pressure in said regulator chamber has become equal to or more than the pressure in said counter-force pressure chamber by the first predetermined pressure.

4. A hydraulic brake apparatus as set forth in claim 1, wherein said second valve means includes a second check valve disposed between said counter-force pressure chamber and said regulator chamber for normally preventing the flow of brake fluid from said regulator chamber to said counter-force pressure chamber, and allowing the flow of brake fluid from said counter-force pressure chamber to said regulator chamber when the pressure in said counter-force pressure chamber has become equal to or more than the pressure in said regulator chamber by the second predetermined pressure.

5. A hydraulic brake apparatus as set forth in claim 1, wherein said cylinder body is formed with a recess opening to outside thereof and communicating with said regulator chamber and said counter-force pressure chamber, and wherein said first valve means and said second valve means are disposed in said recess.

6. A hydraulic brake apparatus as set forth in claim 1, wherein said counter-force means includes a resilient member disposed ahead of said pressure increase valve means and said pressure decrease valve means in said cylinder body for defining said counter-force pressure chamber ahead of said pressure increase valve means and said pressure decrease valve means, and wherein said resilient member is supported by said cylinder body to receive the pressure in said counter-force pressure chamber.

7. A hydraulic brake apparatus as set forth in claim 6, wherein said first valve means includes a first check valve disposed between said counter-force pressure chamber and said regulator chamber for normally preventing the flow of brake fluid from said counter-force pressure chamber to said regulator chamber, and allowing the flow of brake fluid from said regulator chamber to said counter-force pressure chamber when the pressure in said regulator chamber has become equal to or more than the pressure in said counter-force pressure chamber by the first predetermined pressure, and wherein said second valve means includes a second check valve disposed between said counter-force pressure chamber and said regulator chamber for normally preventing the flow of brake fluid from said regulator chamber to said counter-force pressure chamber, and allowing the flow of brake fluid from said counter-force pressure chamber to said regulator chamber when the pressure in said counter-force pressure chamber has become equal to or more than the pressure in said regulator chamber by the second predetermined pressure.

8. A hydraulic brake apparatus as set forth in claim 7, wherein said cylinder body is formed with a recess opening to outside thereof and communicating with said regulator chamber and said counter-force pressure chamber, and wherein said first check valve and said second check valve are disposed in said recess.

9. A hydraulic brake apparatus as set forth in claim 7, wherein the first predetermined pressure is set to be approximately zero.
